(19) United States
(12) Patent Application Publication
(10) Pub. No.: US 2014/0085056 A1
(43) Pub. Date: Mar. 27, 2014

(54) ELECTRONIC APPLIANCES, DIAGNOSTIC SYSTEM FOR ELECTRONIC APPLIANCES AND DIAGNOSTIC METHOD FOR ELECTRONIC APPLIANCES

(71) Applicant: Hyun Woo Kong, Changwon-si (KR)

(72) Inventor: Hyun Woo Kong, Changwon-si (KR)

(73) Assignee: LG ELECTRONICS INC., Seoul (KR)

(21) Appl. No.: 13/884,517

(22) PCT Filed: Feb. 13, 2012
(86) PCT No.: PCT/KR2012/001040

§ 371 Date: Nov. 15, 2013

(30) Foreign Application Priority Data
Feb. 14, 2011 (KR) 10-2011-0012876

(51) Int. Cl. G06K 7/01

(52) U.S. Cl. CPC G06K 7/01
USPC 340/10.51; 340/815.45

(57) ABSTRACT

The present invention relates to electronic appliances, a diagnostic system for electronic appliances and a diagnostic method for electronic appliances, and performs diagnosis of electronic appliances rapidly and accurately by reversely extracting product information from a plurality of images which include product information outputted from the electronic appliances.

### TECHNICAL FIELD

The present invention concerns a home appliance, a home appliance diagnosing system, and a home appliance diagnosing method. More specifically, the present invention relates to a home appliance outputting product information as a sequence of images, and a home appliance diagnosing system and method that analyzes the sequence of images output from the home appliance to thereby perform diagnosis on the home appliance.

### BACKGROUND ART

When a home appliance causes an error while in operation, a user sends an inquiry to a service center and the user by himself takes care of erroneous symptoms or requests a service person to visit and handle it.

However, the user cannot precisely let the service center know the erroneous symptoms by the above measurements, and accordingly, the service center may properly respond to it.

For a user to inform a service center of erroneous symptoms of a home appliance, a scheme recently under considered which outputs the symptoms in the form of a sound that is then transferred to the service center through a phone. However, such scheme may cause a signal distortion due to ambient noise while a signal sound output from the home appliance is received by the phone and accordingly information cannot be precisely transferred to the service center.

Moreover, since the home appliance configures information to be transferred to the service center in the form of a sound by combining multiple signals with different frequencies, signal conversion takes long, and a user needs to hold on the phone until a signal sound output from the home appliance is completely received, thus causing inconvenience.

### DISCLOSURE

### Technical Problem

An object of the present invention is to provide a home appliance, a home appliance diagnosing system, and a home appliance diagnosing method that may more precisely transfer product information to a diagnosing server.

Further, an object of the present invention is to provide a home appliance that may output product information more quickly.

Further, an object of the present invention is to provide a home appliance that may output product information using a plurality of images sequentially output and that may simply configure a displaying apparatus for outputting the plurality of images.

Further, an object of the present invention is to provide a home appliance diagnosing system and a home appliance diagnosing method that may prevent service personnel from being unnecessarily dispatched to take care of malfunctions of a home appliance.

### Technical Solution

A home appliance according to the present invention includes a selecting unit receiving a diagnosis command; a displaying unit outputting an image; and a controller performing control so that product information is converted into a plurality of images according to the diagnosis command entered to the selecting unit and the plurality of images are sequentially output through the displaying unit.

A home appliance diagnosing system according to the present invention includes a home appliance converting product information to a plurality of images and sequentially displaying the plurality of images; a terminal sequentially recognizing the plurality of images displayed on the home appliance, extracting the product information from the plurality of recognized images, and transmitting the product information through a network; and a diagnosing server receiving the product information through the network and performing diagnosis on the home appliance based on the product information.

A home appliance diagnosing method according to the present includes step (a) of converting information of a home appliance into a plurality of images according to a diagnosis command entered through a selecting unit; step (b) of sequentially outputting the plurality of images converted in step (a); and step (c) of sequentially recognizing the images output in step (b), extracting the product information from the plurality of images, and performing diagnosis on the home appliance.

### Advantageous Effects

According to the present invention, a home appliance, a home appliance diagnosing system, and a home appliance diagnosing method may precisely transfer product information of the home appliance to a service center even without a user specifically explaining erroneous symptoms of the home appliance to a service center.

Further, the home appliance according to the present invention may output product information as a sequence of images so that time of outputting product information may be reduced in comparison with when the product information is output as a sound. Accordingly, the same amount of product information may be output within a shorter time.

Further, the home appliance, home appliance diagnosing system and home appliance diagnosing method according to the present invention may precisely transfer product information of the home appliance to a diagnosing server regardless of nose created in the ambient environment where the home appliance is installed.

Further, the home appliance diagnosing system according to the present invention may increase reliability of product information transmitted to the diagnosing server through a user's terminal.

### DESCRIPTION OF DRAWINGS

FIG. 1 shows a home appliance and a home appliance diagnosing system according to an embodiment of the present invention.

FIG. 2 is a block diagram illustrating main components of a home appliance according to an embodiment of the present invention.

FIG. 3 shows an example of the displaying unit shown in FIG. 2.

FIG. 4 shows another example of the displaying unit shown in FIG. 2.

FIG. 5 is a flowchart illustrating a home appliance diagnosing method according to an embodiment of the present invention.

FIG. 6 shows main components of a refrigerator as an example of a home appliance according to an embodiment of the present invention.

### BEST MODE

Advantages and features of the present invention and methods of achieving the same will be apparent by referring to the embodiments described below in detail with reference to the accompanying drawings. However, the present invention is not limited to the embodiments described below and various modifications may be made thereto. The embodiments are merely provided to thoroughly disclose the invention and to convey the category of the invention to one of ordinary skill in the art. The present invention is defined by the appended claims. The same reference numerals denote the same elements throughout the specification.

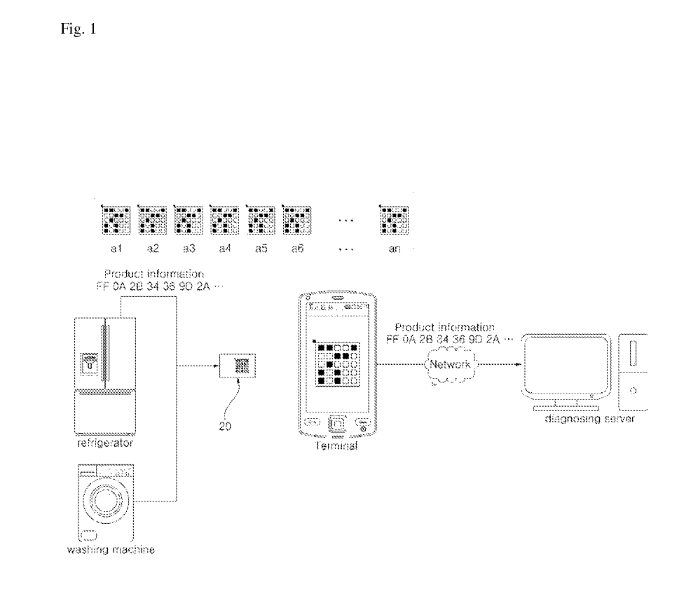

FIG. 1 shows a home appliance and a home appliance diagnosing system according to an embodiment of the present invention. Although FIG. 1 illustrates a refrigerator and a washing machine as examples of the home appliance, the home appliance is not limited thereto.

Referring to FIG. 1, the home appliance diagnosing system according to an embodiment of the present invention includes a home appliance that converts product information to a plurality of images and sequentially displays the plurality of images, a terminal that recognizes the plurality of images sequentially displayed by the home appliance, extracts the product information from the plurality of recognized images, and transmits the product information through a network, and a diagnosing server that is connected to the network and receives the product information transmitted from the terminal and performs diagnosis on the home appliance.

The product information may include at least one of operation information, usage information, and failure information of the home appliance.

The operation information may include configuration information set by a user and information on the operation state of the home appliance. For example, in the case of a refrigerator, the operation information may include temperature configuration information (configuration information) of a refrigerating compartment or freezing compartment as set by a user and a current temperature value (information on the operation state) of the refrigerating compartment or freezing compartment as sensed by a sensing unit.

The usage information may include identification information for identifying the type of the home appliance and information on an operation history of the home appliance. For example, in the case of a refrigerator, the identification information may be, e.g., information for identifying that a home appliance targeted for diagnosis is a refrigerator, and the operation history information may be, e.g., information regarding patterns in which the refrigerator have been operating within a few recent hours.

The failure information may include information on malfunctions of the home appliance. For example, the failure information may be error codes obtained by estimating whether components of the home appliance cause malfunctions from values sensed by a sensing unit 40.

A plurality of images (a1 to an) converted from the product information are sequentially output through a displaying unit 20 provided in the home appliance. A user recognizes the plurality of images (a1 to an) output through the displaying unit 20 by using a terminal. The terminal may be a mobile terminal such as a mobile phone having a video capturing device. As an example, the mobile terminal may provide a standardized interface and flat form for application developers so as to perform such functions as PC (Personal Computers) as well as calling functions. Further, in the mobile terminal may be installed an application for inversely extracting the product information from the images recognized by the video capturing device. The images recognized by the capturing device may be transmitted through a network. Or, the product information may be inversely extracted from the images through the application, and the extracted product information may be transmitted through a network.

The diagnosing server is connected to the network and receives data transmitted through the network and diagnoses the state of the home appliance.

The network may be, e.g., a mobile telecommunication network based on FDMA (Frequency Division Multiple Access), GSM (Global System for Mobile Communications), CDMA (Code Division Multiple Access), W-CDMA (Wideband Code Division Multiple Access), or CDMA 2000, wired Internet or wireless Internet such as Wi-Fi enabling wireless communication between devices through a wireless LAN.

In case inversely extracting the product information from the plurality of images output from the home appliance is performed in the terminal, the diagnosing server directly receives the product information from the terminal through the network and performs diagnosis on the home appliance based on the product information. Such scheme may be applicable to a terminal that may have an image capturing function and may drive an application inversely extracting product information from a captured image. The diagnosing server may include a communication unit that receives product information transmitted from the terminal through the network, a diagnosis data storing unit that stores diagnosis data, and a diagnosing unit that performs diagnosis on the home appliance by comparing the product information received through the communication unit with the diagnosis data stored in the diagnosis data storing unit.

Meanwhile, in case data transmitted through the network is obtained by making, as data, a plurality of images representing the product information of the home appliance, the diagnosing unit inversely extracts the product information from the data transmitted from the communication unit through the network and performs diagnosis on the home appliance based on the extracted product information. Such scheme enables the home appliance to be diagnosed by a terminal that has functions of capturing images, making captured images as data and transferring the data through the network but that cannot drive an application for inversely extracting the product information from the captured images.

Meanwhile, the diagnosing server may further include a diagnosis result displaying unit that outputs a diagnosis result of the home appliance as analyzed by the diagnosing unit to be recognized by stand-by personnel in the service center. Further, the communication unit of the diagnosing server may be configured to transmit a diagnosis result obtained by the diagnosing unit of the diagnosing server to the terminal through a communication network as well as to receive data transmitted from the terminal, and in such case, a user may immediately recognize the diagnosis result through the terminal.

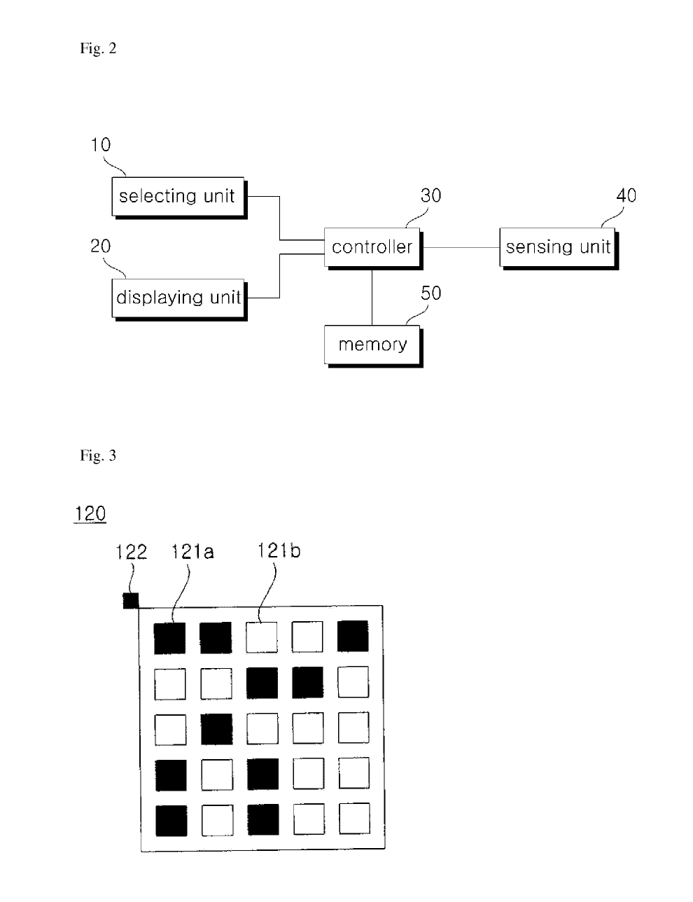

FIG. 2 is a block diagram illustrating main components of a home appliance according to an embodiment of the present invention.

FIG. 3 shows an example of the displaying unit shown in FIG. 2.

Referring to FIG. 2, the home appliance according to an embodiment of the present invention includes a selecting unit 10 for receiving a predetermined diagnosis command from a user, a displaying unit 20 for outputting an image, and a controller 30 for converting product information to a plurality of images according to the diagnosis command entered to the selecting unit 10 and for performing control to enable the plurality of images to be sequentially output through the displaying unit 20.

If a diagnosis command is entered through the selecting unit 10, the controller 30 performs control so that an operation being currently underway is paused or terminated and enters into a diagnosis mode, the product information is split into a plurality of unit data, each split unit data is encoded into a predetermined control signal, and the selecting unit 10 may sequentially output images respectively corresponding to the unit data depending on the control signal.

Referring to FIG. 3, a displaying unit 120, which is an example of the displaying unit 20 shown in FIG. 2, may include a plurality of light emission members 121 that emit light in a predetermined pattern according to the control signal from the controller 30. FIG. 1 shows an example where a plurality of images a1 to an are sequentially output according to the light emission pattern of the plurality of light emission members 121. Each of image a1 to an respectively corresponds to each of unit data split from the product information and may be output at a predetermined time interval. In FIG. 3, reference 121a denotes a light-off light emission member, and reference 121b denotes a light-on light emission member.

The displaying unit 120 has the plurality of light emission members 121 arranged vertically/horizontally in a grid pattern. The shape of an image displayed varies depending on the pattern in which the plurality of light emission members 121 emit light. The light emission members 121 may be LEDs (Light Emitting Diodes).

The displaying unit 120 may include a positioning marking unit 122. The positioning marking unit 122 marks a position where an image is recognized which is formed according to the light emitting pattern of the light emission members 121. In other words, a position which functions as a standard when an image displayed on the displaying unit 120 is read is marked. When images captured by the terminal is analyzed by an application, the images may be arranged with respect to the positioning marking unit 122, thereby providing exact information.

Meanwhile, a sensing unit 40 senses the operation state of the home appliance. The sensing unit 40 may sense operation information of various devices constituting the home appliance and state information such as temperature, moisture, dryness, power consumption, and electric conductivity which need to be sensed to control the devices.

A memory 50 may store control data of the home appliance and product information constituted of operation information of the home appliance, usage information and/or failure information.

The controller 30 may control the overall operation of the home appliance according to the control data stored in the memory 50, and upon diagnosis, may perform control so that the product information stored in the memory 50 is called out and split into a plurality of unit data, each split unit data is encoded into a predetermined control signal, and the displaying unit 120 sequentially outputs images corresponding to each unit data depending on the control signal.

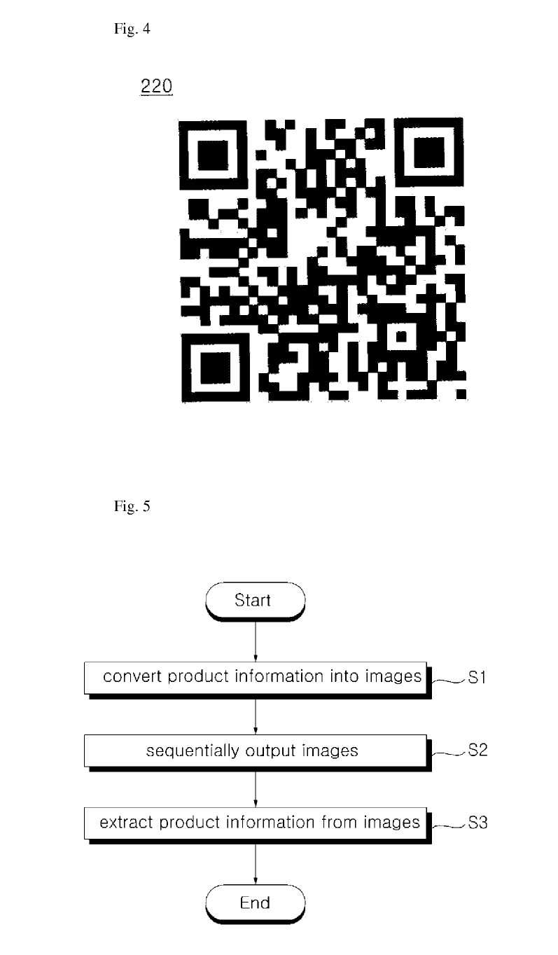

FIG. 4 shows another example of the displaying unit shown in FIG. 2. Referring to FIG. 4, the displaying unit 220 may sequentially output a sequence of QR (Quick Response) codes including product information according to a control signal of the controller 30. Here, the QR codes are matrix-like two-dimensional bar codes that represent information in a lattice pattern. The displaying unit 220 may include an LED panel to display the QR codes.

FIG. 5 is a flowchart illustrating a home appliance diagnosing method according to an embodiment of the present invention. Referring to FIG. 5, the home appliance displaying area according to an embodiment of the present invention includes a step S1 of converting product information of a home appliance to a plurality of images according to a diagnosis command entered through the selecting unit 10, a step S2 of sequentially outputting the plurality of converted images, and a step S3 of sequentially recognizing the output images, extracting the product information from the recognized images, and performing diagnosis on the home appliance.

Steps S1 and S2 are performed by the home appliance. As described above, if a diagnosis command is entered through the selecting unit 10, the controller 30 performs control so that the operation currently underway is paused or terminated and enters into a diagnosis mode, the product information is split into a plurality of unit data, each split unit data is encoded into a predetermined control signal, and the displaying unit 20 sequentially outputs images corresponding to each unit data according to the control signal.

In step S3, extracting the product information from a sequence of images output from the home appliance is conducted by the terminal or the diagnosing server. In either way, the sequence of images including the product information output from the home appliance is recognized through a video capturing device provided in the terminal, but inversely extracting the product information from the images recognized through the video capturing device may be carried out by either the terminal or the diagnosing server.

For example, in case inverse extraction of the product information from the plurality of images output from the home appliance is done by the terminal, the terminal transmits the extracted product information to the diagnosing server through the network, and the diagnosing server performs diagnosis on the home appliance by analyzing the received product information.

Otherwise, in case the terminal merely captures the images output from the home appliance and transmits image data through the network, the diagnosing server inversely extracts the product information from the image data transmitted through the network and diagnoses the home appliance through the extracted product information.

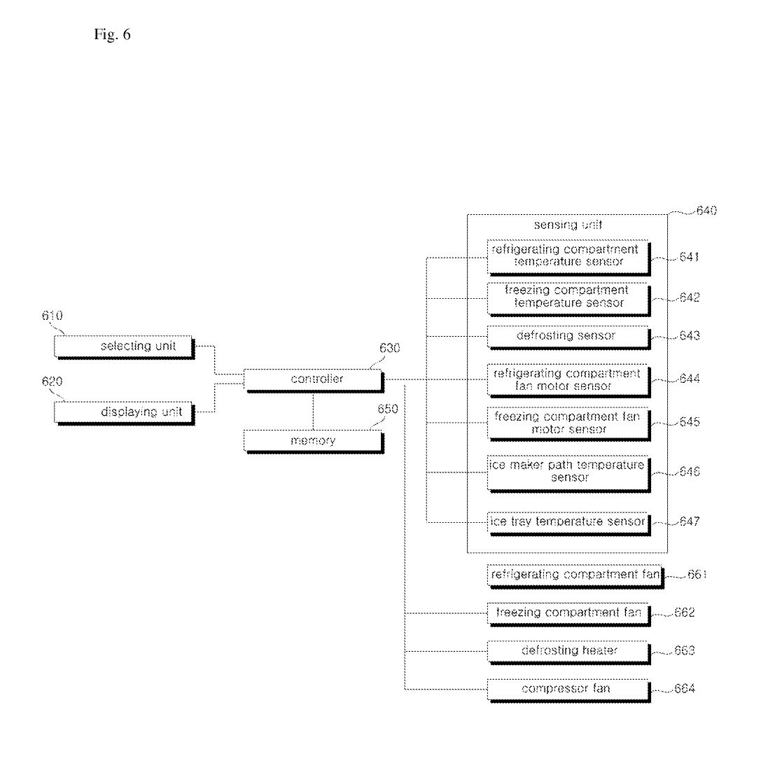

FIG. 6 shows main components of a refrigerator as an example of a home appliance according to an embodiment of the present invention. Referring to FIG. 6, the refrigerator, an example of a home appliance according to the present invention, may include a selecting unit 610, a displaying unit 620, a controller 630, a sensing unit 640, and a memory 650. The selecting unit 610, the displaying unit 620, the controller 630, the sensing unit 640, and the memory 650 are denoted with reference numerals different from the selecting unit 10, the displaying unit 20, the controller 30, the sensing unit 40, and the memory 50, respectively, as described above in connection with FIG. 2 for the purpose of being recognized as components of the refrigerator that is an example of the home appliance according to the present invention, but the description on the components shown in FIG. 2 may apply thereto. However, various examples of the sensing unit 640 are specifically illustrated in FIG. 6.

In this embodiment, the refrigerator may include a refrigerating compartment and a freezing compartment, a refrigerating compartment fan 661 for blowing cold air to the refrigerating compartment, a freezing compartment fan 662 for blowing cold air to the freezing compartment, a defrosting heater 663 provided when the refrigerator has a food defrosting function, and a condenser fan 664 for dissipating heat generated from a condenser condensing a coolant.

The sensing unit 640 may include a refrigerating compartment temperature sensor 641 sensing the temperature of the refrigerating compartment, a freezing compartment temperature sensor 642 sensing the temperature of the freezing compartment, a defrosting sensor 643 sensing frost generated on the surface of an evaporator to determine whether a defrosting operation is performed, a refrigerating compartment fan motor sensor 644 sensing whether the refrigerating compartment fan 661 normally operates, and/or a freezing compartment fan motor sensor 645 sensing whether the freezing compartment fan 662 normally operates.

Further, when the refrigerator has an ice maker to make ice, the ice maker may include a water path through which water necessary to make ice flows and an ice tray in which water coming through the water path is gathered and turns into ice in a predetermined shape. The sensing unit 640 may further include an ice maker path temperature sensor 646 measuring the temperature of water in the water path and an ice tray temperature sensor 647 measuring the temperature in the ice tray.

The images output through the displaying unit 620 of the refrigerator may include information (operation information) on values sensed by the sensing unit 641 to 647 and malfunction information (failure information) obtained based on the sensed values.

It may be understood by one of ordinary skill in the art that many other modifications and variations may be made to the present invention without departing from the essential features of the invention. Accordingly, the embodiments described thus far should be construed as being exemplary but not as limiting. The scope of the invention is defined by the claims rather than the detailed description above, and it should be also interpreted that all the modifications and variations induced from the meaning and scope of the claims and the equivalents thereof are also within the scope of the invention.

1. A home appliance comprising:
a selecting unit receiving a diagnosis command;
a displaying unit outputting an image; and
a controller performing control so that product information is converted into a plurality of images according to the diagnosis command entered to the selecting unit and the plurality of images are sequentially output through the displaying unit.

2. The home appliance of claim 1, wherein the controller performs control so that the product information is split into a plurality of unit data, each split unit data is encoded into a predetermined control signal, and the displaying unit sequentially outputs images corresponding to each unit data according to the control signal.

3. The home appliance of claim 2, wherein the displaying unit includes a plurality of light emission members that emit light in a predetermined pattern according to the control signal.

4. The home appliance of claim 3, wherein the displaying unit has the plurality of light emission members arranged vertically and horizontally in a grid pattern.

5. The home appliance of claim 3, wherein the light emission members include LEDs (Light Emitting Diodes).

6. The home appliance of claim 3, wherein the displaying unit further includes a positioning marking unit marking a position where an image is recognized which is formed by a light emitting pattern of the plurality of light emission members.

7. The home appliance of claim 2, wherein the displaying unit sequentially outputs a plurality of QR (Quick Response) codes according to the controls signal.

8. The home appliance of claim 7, wherein the displaying unit includes an LED (Light Emitting Diode) panel.

9. The home appliance of claim 1, wherein the controller performs control so that the plurality of images are output at a predetermined time interval through the displaying unit.

10. The home appliance of claim 1, wherein the product information includes at least one of operation information, usage information, and failure information of the home appliance.

11. A home appliance diagnosing system comprising:
a home appliance converting product information to a plurality of images and sequentially displaying the plurality of images;
a terminal sequentially recognizing the plurality of images displayed on the home appliance, extracting the product information from the plurality of recognized images, and transmitting the product information through a network; and
a diagnosing server receiving the product information through the network and performing diagnosis on the home appliance based on the product information.

12. The home appliance diagnosing system of claim 11, wherein the terminal is a mobile terminal including a video capturing device.

13. The home appliance diagnosing system of claim 11, wherein the diagnosing server comprises,
a communication unit receiving the product information transmitted through the network;
a diagnosis data storing unit storing diagnosis data; and
a diagnosing unit performing diagnosis on the home appliance by comparing the product information received through the communication unit with the diagnosis data stored in the diagnosis data storing unit.

14. A home appliance diagnosing method comprising:
step (a) of converting information of a home appliance into a plurality of images according to a diagnosis command entered through a selecting unit;
step (b) of sequentially outputting the plurality of images converted in step (a); and
step (c) of sequentially recognizing the images output in step (b), extracting the product information from the plurality of images, and performing diagnosis on the home appliance.

15. The home appliance diagnosing method of claim 14, wherein step (a) comprises,
step (a-1) of splitting the product information into a plurality of unit data;
step (a-2) of encoding each split unit data into a predetermined control signal; and
step (a-3) of sequentially outputting images corresponding to each unit data through the displaying unit according to the control signal.

16. The home appliance diagnosing method of claim 14, wherein step (c) comprises,
a step of sequentially recognizing the images output in step (b), extracting the product information from the images, and transmitting the product information through a network; and
a step of receiving the product information through the network and performing diagnosis on the home appliance based on the product information.

17. The home appliance diagnosing method of claim 14, wherein step (C) comprises,
a step of sequentially recognizing the images output in step (b) and transmitting the images through a network;
a step of extracting the product information from the sequence of images transmitted through the network; and
a step of performing diagnosis on the home appliance based on the extracted product information.

18. The home appliance diagnosing method of claim 14, wherein step (b) comprises a step of forming the plurality of images by controlling a light emitting pattern of a plurality of light emission members.

19. The home appliance diagnosing method of claim 14, wherein step (b) comprises a step of forming the plurality of images in QR (Quick Response) codes.

20. The home appliance diagnosing method of claim 14, wherein step (b) outputs the plurality of images at a predetermined time interval.
